(19) United States
(12) Patent Application Publication
(10) Pub. No.: US 2026/0160564 A1
(43) Pub. Date: Jun. 11, 2026

(54) METHOD AND SYSTEM FOR RECOMMENDING GENERATIVE AI BASED ROUTE

(71) Applicant: HYUNDAI AUTOEVER CORP., Seoul (KR)

(72) Inventor: Yun Haeng Lee, Seoul (KR)

(73) Assignee: HYUNDAI AUTOEVER CORP., Seoul (KR)

(21) Appl. No.: 19/413,490

(22) Filed: Dec. 9, 2025

(30) Foreign Application Priority Data
Dec. 11, 2024 (KR) 10-2024-0183285

(51) Int. Cl. G01C 21/34

(52) U.S. Cl. CPC G01C 21/3446; G01C 21/3476; G01C 21/3492

(57) ABSTRACT

A method for recommending a driving route for a mobile device includes automatically generating a first prompt for generating, using generative AI, a response to a destination search request of a driver. The first prompt is automatically generated to include internal environment information received from an internal system of the mobility device. The method also includes transmitting the first prompt to a generative AI system and receiving one or more destinations corresponding to the destination search request from the generative AI system in response to transmitting the first prompt. The response is generated using road traffic information received from a navigation server communicatively coupled to the mobility device. The method additionally includes determining a recommended destination from among the one or more destinations received from the generative AI system.

### CROSS-REFERENCE TO RELATED APPLICATION

This application claims the benefit of and priority from Korean Patent Application No 10-2024-0183285, filed on Dec. 11, 2024, the entire contents of which are hereby incorporated herein by reference.

### TECHNICAL FIELD

The present disclosure relates to a method and system for recommending a generative AI based route, and more particularly, to a method and system for recommending a route optimized for a driver by using generative AI.

### BACKGROUND

The statements in this section merely provide background information related to the present disclosure and may not constitute prior art.

Conventional navigation systems use a method of entering a destination or setting a route by using a touch screen or a physical button. However, since a driver should constantly watch a screen or manipulate the system manually, this can cause visual and physical burdens during driving.

Also, since the system can only recognize predefined commands or keywords, a problem occurs in that the system fails to provide a natural language-based intuitive user interface. In addition, detailed driving assistance functions, such as route corrections and lane changes, are restrictive, and real-time traffic information often fails to be adequately reflected.

### SUMMARY

Aspects of the present disclosure provide a method for providing drivers with a safer and more intuitive navigation experience by overcoming the limitations of the related art.

Aspects of the present disclosure provide a navigation system that utilizes a generative artificial intelligence (AI)-based voice recognition technology, thereby ensuring both safety and convenience during driving.

Aspects of the present disclosure provide a navigation system that provides natural destination search and route search functions through a driver's utterance, provides optimal route setting linked to real-time traffic information, and automates and simplifies driving assistance functions such as lane changes that reflect real-time traffic information during driving.

Aspects of the present disclosure provide a method and system for recommending a route to provide recommended destinations and operating information for the recommended destinations by using generative AI in response to a destination search request.

Aspects of the present disclosure provide a method and system for recommending a route to provide route guidance considering features of passengers by using generative AI in response to a route guidance request.

Aspects of the present disclosure provide a method and system for recommending a route to provide lane change guidance considering real-time traffic information to a destination by using generative AI in response to a lane-level guidance request.

The objects of the present disclosure are not limited to those mentioned above. Additional objects of the present disclosure, that are not mentioned herein, should be more clearly understood by those having ordinary skill in the art from the following description.

According to an aspect of the present disclosure, a method, performed by a computing system, for recommending a driving route for a mobile device is provided. The method includes automatically generating a first prompt for generating, using generative AI, a response to a destination search request of a driver. The first prompt is automatically generated to include internal environment received from an internal system of the mobility device. The method also includes transmitting the first prompt to a generative AI system and receiving one or more destinations corresponding to the destination search request from the generative AI system in response to transmitting the first prompt. The response is generated using road traffic information received from a navigation server communicatively coupled to the mobility device. The method additionally includes determining a recommended destination from among the one or more destinations received from the generative AI system.

In some embodiments, the destination search request includes a service facility corresponding to the destination search request and a base of the service facility.

In some embodiments, determining the recommended destination includes automatically generating a second prompt for determining, using generative AI, the recommended destination, the second prompt being automatically generated to include the one or more destinations and operating information of a service provided by each of the one or more destinations. The method also includes transmitting the second prompt to the generative AI system and receiving the recommended destination from the generative AI system in response to transmitting the second prompt. The recommended destination is determined based on an evaluation item for each of the one or more destinations.

In some embodiments, the evaluation item includes the operating information of the service provided by each of the one or more destinations.

In some embodiments, the second prompt is automatically generated to further include route information on each of the one or more destinations, and the evaluation item includes the route information on each of the determined one or more destinations.

In some embodiments, the second prompt is automatically generated to further include nearby traffic information on each of the one or more destinations, and the evaluation item includes the nearby traffic information on each of the determined one or more destinations.

In some embodiments, the evaluation item includes one or more evaluation items, and the recommended destination receives a score of a reference value or more with respect to all of the one or more evaluation items.

In some embodiments, the operating information includes real-time remaining parking space information.

In some embodiments, the operating information includes information on operating hours of the service.

According to another aspect of the present disclosure, a method, performed by a computing system, for recommending a driving route for a mobile device is provided. The method includes generating a prompt for generating, using generative AI, a response to a route guidance request of a driver. The prompt is generated to include destination data included in the route guidance request. The method also includes transmitting the prompt to a generative AI system and receiving a driving route corresponding to the route guidance request from the generative AI system in response to transmitting the prompt. The driving route is determined using route attribute information of that corresponds to passenger information of a passenger riding in the mobility device and road traffic information received from a navigation server communicatively coupled to the mobility device.

In some embodiments, the route guidance request includes voice data uttered by the driver, and the destination data included in the route guidance request is obtained by converting the voice data into text data.

In some embodiments, the passenger information includes age information of the passenger riding in the mobility device.

In some embodiments, the passenger information includes gender information of the passenger riding in the mobility device.

In some embodiments, the method further comprises outputting the route attribute information corresponding to the driving route as a voice output in the mobility device.

According to still another aspect of the present disclosure, a method, performed by a computing system, for recommending a driving route for a mobile device is provided. The method includes generating a prompt for generating, using generative AI, a response to a lane level guidance request of a driver. The prompt is generated to include the lane level guidance request and internal environment information received from an internal system of the mobility device. The method also includes transmitting the prompt to a generative AI system and receiving a lane level corresponding to the lane level guidance request and information on a point where lane change to the lane level is to be performed, from the generative AI system in response to transmitting the prompt. The information on the point where the lane change is to be performed is determined using forward traffic information received from one or both of a navigation server communicatively coupled to the mobility device or the internal system of the mobility device.

In some embodiments, the information on the point where lane change is to be performed includes location information for moving from a current lane level to an intermediate lane level and location information for moving from the intermediate lane level to a target lane level.

In some embodiments, the forward traffic information includes information on another mobility device driving ahead within a certain distance of the mobility device. The forward traffic information may be received from the internal system of the mobility device.

In some embodiments, the forward traffic information includes traffic information for each lane level from a location of the mobility device to a destination of the deriver. The forward traffic information may be received from the navigation server communicatively coupled to the mobility device.

In some embodiments, the method further includes outputting an avoidance route guidance using the forward traffic information.

In some embodiments, the internal environment information includes passenger information of the mobility device.

### BRIEF DESCRIPTION OF THE DRAWINGS

The above and other aspects and features of the present disclosure should become more apparent the following detailed description taken in conjunction with the accompanying drawings, in which:

FIG. 1 is a schematic diagram illustrating a route recommendation system, according to some embodiments of the present disclosure;

FIG. 2 is a flow chart illustrating a route recommendation method, according to an embodiment the present disclosure;

FIG. 3 is a view illustrating an example of a destination search request uttered by a driver, according to an embodiment of the present disclosure;

FIG. 4 is a view illustrating an example of providing information on a recommended destination in response to a destination search request, according to an embodiment of the present disclosure;

FIG. 5 is a view illustrating an example of a destination list displayed on a navigation device in response to a destination search request, according to an embodiment of the present disclosure;

FIG. 6 is a flow chart illustrating a route recommendation method, according to another embodiment the present disclosure.

FIG. 7 is a view illustrating an example of a route guidance request uttered by a driver, according to an embodiment of the present disclosure;

FIG. 8 is a view illustrating a correspondence relation between passenger information of a driver's mobility device and attribute information of a predefined route, according to an embodiment of the present disclosure;

FIG. 9 is a view illustrating an example of acquiring passenger information of a driver's mobility device through a camera inside the mobility device, according to an embodiment of the present disclosure;

FIGS. 10A-10D are views illustrating an example of providing a driving route to a driver based on attribute information of a predefined route corresponding to passenger information of a driver's mobility device, according to embodiments of the present disclosure;

FIG. 11 is a flow chart illustrating a route recommendation method, according to another embodiment the present disclosure.

FIG. 12 is a view illustrating an example of a lane level guidance request uttered by a driver, according to an embodiment of the present disclosure;

FIG. 13 is a view illustrating an example of acquiring information on a mobility device driving within a certain distance ahead of a driver's mobility device, according to an embodiment of the present disclosure;

FIG. 14 is a view illustrating an example of providing avoidance route guidance using lane level-specific traffic information to a destination, according to an embodiment of the present disclosure;

FIG. 15 is a view illustrating an example of a voice output of a lane level and a point where lane change to the lane level is performed, based on a lane level guidance request, according to an embodiment of the present disclosure; and

FIG. 16 is a hardware schematic diagram illustrating a computing device. according to some embodiments of the present disclosure.

### DETAILED DESCRIPTION

Hereinafter, embodiments of the present disclosure are described with reference to the accompanying drawings. Advantages and features of the present disclosure and methods of accomplishing the same should be more clearly understood from the following detailed description taken in conjunction with the accompanying drawings. The present disclosure may, however, be embodied in many different forms and should not be construed as being limited to the embodiments set forth herein. Rather, these embodiments are provided to make the present disclosure thorough and complete and to fully convey the concept of the present disclosure to those having ordinary skill in the art, and the present disclosure is defined only by the appended claims.

In adding reference numerals to the components of each drawing, it should be noted that the same reference numerals are assigned to the same components as much as possible even when the components are shown in different drawings. In addition, in describing the present disclosure, where it was determined that a detailed description of the related well-known configuration or function would obscure the gist of the present disclosure, the detailed description thereof has been omitted.

Unless otherwise defined, all terms used in the present specification (including technical and scientific terms) may be used in a sense that can be commonly understood by those having ordinary skill in the art. In addition, the terms defined in the commonly used dictionaries should not be ideally or excessively interpreted unless they are specifically defined otherwise herein. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are used only to distinguish the components from other components, and the nature or order of the components is not limited by the terms. When a component is described as being “connected,” “coupled” or “contacted” to another component, the component may be directly connected to or contacted with the other component, but it should be understood that another component also may be “connected,” “coupled” or “contacted” the two each components.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

Hereinafter, embodiments of the present disclosure are described in detail with reference to the accompanying drawings.

In the present disclosure, a mobility device may have the same meaning as a vehicle. In the present disclosure, a generative AI may have the same meaning as a generative AI system. In the present disclosure, a navigation device may have the same meaning as a navigation system.

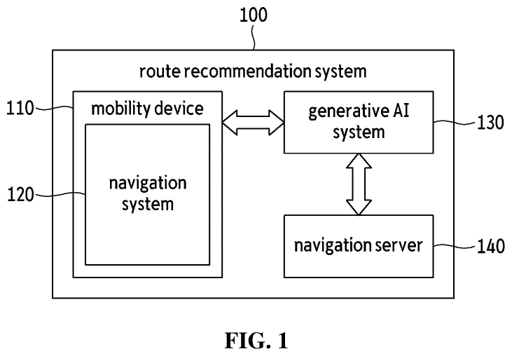

FIG. 1 is a schematic diagram illustrating a route recommendation system according to some embodiments of the present disclosure.

A route recommendation system 100 according to some embodiments of the present disclosure may include a mobility device 110, a navigation system 120, a generative AI system 130, and a navigation server 140.

The mobility device 110 may refer to a means, facility and service necessary to move people or objects. For example, the mobility device 110 may include a vehicle, a bus, and a truck, which are traditional transportation means. As another example, the mobility device 110 may include a small personal transportation means such as an electric kickboard, an electric bicycle, and an electric wheel, which are personal mobility means. The mobility device 110 is not limited to the above examples, and may refer to another means (e.g., a new fashionable means), facility, or service required to move people or objects.

The navigation system 120 may refer to an electronic device or software that identifies a user's current location by using a global positioning system (GPS), a digital map, a built-in compass, and the like and guides a route to a destination. For example, the navigation system 120 may refer to a device embedded in a dashboard of the mobility device 110. In another example, the navigation system 120 may refer to a device that performs a route guidance function through an infotainment system of the mobility device 110.

The generative AI system 130 may refer to an AI system that generates new contents such as text, images, and voices by using a machine learning model.

The navigation server 140 may relay data between the generative AI system 130 and an external data source. For example, the navigation server 140 may transmit data such as traffic conditions and road conditions to the generative AI system 130.

The navigation system 120 of the route recommendation system according to an embodiment of the present disclosure automatically generates a prompt for generating a response to a driver's destination search request by using the generative AI system 130, In an embodiment, the prompt may be automatically generated to include internal environment information of the vehicle, which is received from an internal system of the driver's vehicle.

The destination search request may be a request for the driver to search for a destination located near a specific area. For example, the destination search request may be a request for searching for a parking lot located near Gyeongbokgung Palace. The one or more destinations may refer to service facilities included in the destination search request. A parking lot located within a certain distance of Gyeongbokgung Palace may be determined in response to the driver's request for searching for a destination, “Find a parking lot near Gyeongbokgung Palace.”

The internal system may refer to an electronic device, such as a camera or an infotainment system, installed inside the vehicle. The internal environment information may refer to information within various vehicle compartments that may be referenced to generate an optimized response to the user's destination search request. In one example, a response, to the destination search request, that corresponds to a physical condition such as a fatigue and drowsiness of a passenger, may be generated by referring to the physical condition as the internal environment information. In another example, the internal environment information may mean an indoor environment such as indoor temperature and humidity. In yet another example, the internal environment information may mean the driver's driving habit data.

The navigation system 120 of the route recommendation system according to an embodiment of the present disclosure may transmit the prompt to the generative AI system 130, and may determine one or more destinations corresponding to the destination search request from the generative AI system 130 in response to the transmission of the prompt. The response may be generated by the generative AI by using road traffic information received from the navigation server of the vehicle.

The road traffic information may mean data related to a real-time state of a road section from a location of the driver to a location corresponding to the destination search request. For example, the road traffic information may mean a real-time traffic congestion level. In another example, the road traffic information may mean a road condition according to construction or weather conditions. In another example, the road traffic information may mean information related to an expected congested section.

The navigation system 120 of the route recommendation system according to an embodiment of the present disclosure may determine (e.g., select) a recommended destination from among the determined one or more destinations.

The navigation system 120 of the route recommendation system according to an embodiment of the present disclosure may output the recommended destination and operating information of the service provided by the recommended destination. The service provided by the recommended destination may include, for example, facilities for convenience of the driver, that are provided by facilities such as a parking lot, a restaurant, and a gas station. The operating information may mean real-time information required to use a service provided by each of the determined one or more destinations. When the destination search request includes a parking lot, the operating information may mean a current parking available place. In another example, when the destination data includes a restaurant, the operating information may mean today's operating time of the restaurant. In another example, when the destination data includes a gas station, the operating information may mean the current number of available charging spots at the gas station. Since a case in which the driver arrives at the destination but fails to use the service may be prevented in consideration of the operating information, the waste of time of the driver may be avoided and convenience of the driver may be enhanced. The recommended destination may be determined depending on how suitable it is for the driver in consideration of the operating information. For example, when the destination search request includes a parking lot, the recommended destination may have a large number of currently available parking spaces. In another example, when the destination search request includes a restaurant, the recommended destination may be a destination of which operating hours for today are far from the current time. In another example, when the destination search request includes a gas station, the recommended destination may be a destination with a large number of current charging spots.

The navigation system 120 of the route recommendation system according to an embodiment of the present disclosure may output the recommended destination and the operating information of the service provided by the recommended destination as an audio output (e.g., a voice output). Also, in some embodiments, a destination list including the determined one or more destinations may be output. The destination list may be displayed to include names of the determined one or more destinations. In addition, the destination list may be displayed with respect to the recommended destination in a manner different from the one or more destinations. For example, when the one or more destinations are a Gyeongbokgung public parking lot, a National Museum of Modern and Contemporary Art parking lot, and a Northgate building parking lot, and when the recommended destination is a Gyeongbokgung public parking lot, the destination list may be displayed as “Gyeongbokgung public parking lot (recommended).” Therefore, the navigation system 120 may search for and recommend a destination optimized for the driver, thereby saving the driver's time and increasing convenience during driving.

The navigation system 120 of the route recommendation system according to another embodiment of the present disclosure may automatically generate a prompt for generating a response to the driver's route guidance request of the mobility device 110 by using the generative AI system 130. The route guidance request may mean a request for the driver to be provided with a route for arriving at a specific destination. For example, the route guidance request may mean a request for receiving a route from the current location of the mobility device 110 to the Gyeongbokgung Palace public parking lot as a destination from the navigation system 120. In addition, the prompt may be automatically generated to include destination data included in the route guidance request. The destination data may mean an arrival point of a route according to the route guidance request. For example, when the driver requests route guidance to the Gyeongbokgung Palace public parking lot, the destination data may mean the Gyeongbokgung Palace public parking lot. Automatically generating the prompt may mean that the generative AI system automatically generates the prompt from the route guidance request without a driver's additional manipulation. Accordingly, in an embodiment, the generative AI system 130 automatically generates a prompt without a separate manipulation during driving so that the driver may fully concentrate on driving, thereby increasing convenience and stability. In an embodiment, the prompt may include input data converted into a form operable by the generative AI system 130.

The navigation system 120 of the route recommendation system according to an embodiment of the present disclosure may transmit the prompt to the generative AI system 130. In addition, the navigation system 120 may receive a driving route corresponding to the determined driving route request from the generative AI system 130 as a response to the transmission of the prompt. The driving route may be determined by the generative AI system 130 by using attribute information of a predefined route (also sometimes referred to herein as “route attribute information”) corresponding to passenger information of the driver's mobility device and road traffic information received from the navigation server communicatively coupled or linked to the mobility device.

The passenger information may refer to information that may be referenced to provide route guidance optimized for the purpose or preference of passengers of the mobility device 110. In one example, the passenger information may be an age and/or gender of a passenger of the mobility device 110. In another example, the passenger information may refer to schedule data of a passenger. In another example, the passenger information may refer to information on a passenger's taste and interest. In another example, the passenger information may refer to data related to whether a socially disadvantaged person, such as an infant, an elderly person, and a disabled person, rides together. The attribute information on the predefined route may refer to attribute information predefined depending on features on the route. For example, a route with a high percentage of paved roads may be defined as a “comfortable road.” In another example, a route with low vehicle traffic and close to the shortest distance may be defined as a “fast road.” In another example, a route with not many buildings around the road and a high percentage of natural objects may be defined as a “scenic road.” In another example, a route with a low toll may be defined as an “economic road.”

The attribute information of the predefined route, that corresponds to the passenger information, may refer to attribute information of the predefined route corresponding to the general preference according to the age or gender of the passenger. For example, a couple riding with a child may prefer a safe route for the child's safety, and thus may correspond to the “comfortable road.” In another example, an adult male in his 20s driving alone often prefers to arrive at the destination in a short time, and thus may correspond to the “fast road.” In another example, a man and a woman in their 20s or 30s riding may often be lovers or married couples, and thus tend to seek psychological refreshment through driving, and thus may correspond to the “scenic road.” In another example, an adult in his 40s or 50s or older riding may often be raising children, and thus tend to be concerned about financial aspects, and thus may correspond to the “economical route.”

Therefore, the driver does not have to search for or think about a route corresponding to the passenger's information separately because the navigation system 120 may acquire the passenger information and may automatically provide guidance to a route corresponding to the passenger information, thereby minimizing the waste of time and concentrating on driving to increase stability and safety.

The navigation system 120 of the route recommendation system according to an embodiment of the present disclosure may output attribute information of the route corresponding to the received driving route. For example, when a couple rides with an infant, a driving route corresponding to the “comfortable road” may be provided, and a message guiding them to a route passing through the “comfortable road” may be displayed on the screen of the navigation system 120. In another example, when a couple rides with an infant, a driving route corresponding to the “comfortable road” may be provided, and a message guiding them to a route passing through the “comfortable road” may be output as audio (e.g., as a voice).

The navigation system 120 of the route recommendation system according to an embodiment of the present disclosure may automatically generate a prompt for generating a response to the driver's lane level guidance request of the mobility device 110 by using the generative AI system 130. In addition, in an embodiment, the prompt may be automatically generated to include the lane level guidance request and internal environmental information received from the internal system of the driver's vehicle.

The lane level guidance request may mean a request for driving lane level guidance optimized for the driver to a destination of the driving route guidance while the driver is receiving the driving route guidance of the navigation system 120. Automatically generating the prompt may mean that the generative AI system automatically generates the prompt from the lane level guidance request without the driver's additional manipulation. Accordingly, in an embodiment, the generative AI system 130 automatically generates a prompt without a separate manipulation while driving so that the driver may fully concentrate on driving, thereby increasing convenience and stability. In an embodiment, the prompt may include input data converted into a form in which the generative AI system 130 is operable. The prompt may be generated to include the lane level guidance request and internal environment information received from the internal system of the driver's vehicle.

The navigation system 120 of the route recommendation system according to an embodiment of the present disclosure may transmit the prompt to the generative AI system 130. In addition, the navigation system 120 may receive a lane level corresponding to the determined lane level guidance request and information on a point where lane change to the lane level is to be performed, from the generative AI system 130 as a response to the transmission of the prompt. In an embodiment, the lane level may be by from the generative AI by using forward traffic information received from the navigation server communicatively coupled or linked to the driver's vehicle or the internal system of the vehicle. The lane level corresponding to the lane level guidance request may mean a lane level that the driver should use to reach a destination. For example, while driving to Gyeongbokgung Palace's public parking lot, the driver may receive, from the generative AI system 130, a guidance to use a first, second or third lane to make a left turn 1 km ahead in response to a lane level guidance request for which lane to use to get to Gyeongbokgung Palace public parking lot from the driver's current location.

The information on a point where lane change is to be performed may include a location at which the driver should move to a lane level corresponding to the lane level guidance request. For example, the information on a point where lane change is to be performed may mean a location of 200 M ahead, which may be a location for moving from the driver's current location to the first lane in order to make a left turn in front of 1 KM ahead. In an embodiment, the information on a point where lane change is to be performed may be determined by the generative AI system 130 by using the forward traffic information.

The forward traffic information may mean traffic information that may be referenced to recommend a lane level that matches the driver's purpose or preference on a route to a destination in response to the driver's lane level guidance request. For example, the forward traffic information may mean traffic volume or road condition from the front of the location to the destination. For example, in order to make a left turn in front of 1 KM ahead, it is necessary to move from the driver's current location to the first lane, but when there is a lot of traffic in the first lane from the driver's location to the front 500 M, the lane change location to the lane level may be determined as the location of 500 M ahead from the generative AI system 130. In another example, in order to make a left turn in front of 1 KM ahead, it is necessary to move from the driver's current location to the first lane, but when a first lane road is under construction from the driver's location to 500 M ahead, the lane change location to the lane level may be determined as the location of 500 M ahead from the generative AI system 130.

Accordingly, since the generative AI system determines the information on a point where lane change is to be performed, in consideration of the forward traffic information, an optimal lane change location may be determined, thereby greatly reducing traffic delay time. Also, the possibility of collision between vehicles may be minimized so that safe lane change is possible.

The navigation system 120 of the route recommendation system according to an embodiment of the present disclosure may provide the driver with the received lane level and the information on a point where lane change is to be performed. As a result, the navigation system 120 may provide a comfortable driving experience by providing a route optimized for the driver's preference and external environment.

The route recommendation system according to embodiments of the present disclosure should be more clearly understood by those having ordinary skill in the art from the embodiments described below. In addition, the technical sprits that should be understood from the above-described embodiments of the route recommendation system may be reflected in the embodiments described below, even when the description in not repeated therein.

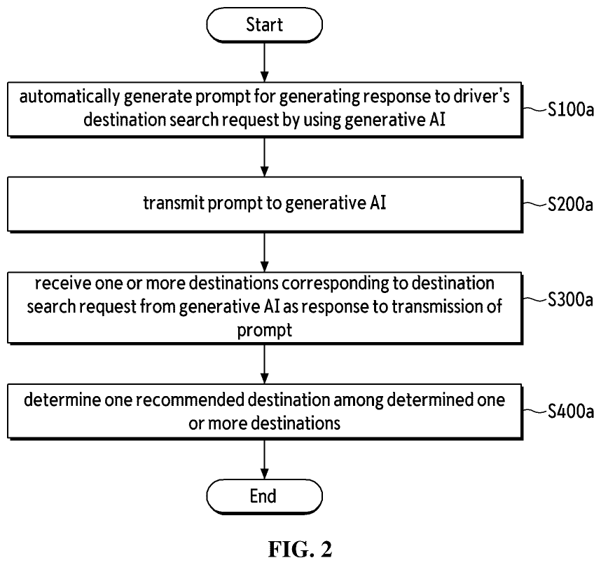

FIG. 2 is a flow chart illustrating a route recommendation method according to an embodiment of the present disclosure. The route recommendation method according an embodiment, as shown in FIG. 2, may include a step or operation S100a of automatically generating a first prompt for generating a response to a driver's destination search request by using a generative AI. The first prompt may be automatically generated to include internal environment information of a vehicle, that is received from an internal system of the driver's vehicle. The method may also include a or operation. step S200a of transmitting the first prompt to the generative AI. The method may additionally include a step or operation S300a of determining one or more destinations corresponding to the destination search request from the generative AI as a response to the transmission of the first prompt. The response may be generated using road traffic information received from a navigation server communicatively coupled or linked to the vehicle. The method may further include a step S400a of determining a recommended destination from among the determined one or more destinations.

When a response to the destination search request is generated, a destination optimized for a user may be recommended using the road traffic information received from the navigation server. For example, routes from the navigation server to the destination may be recommended by excluding a destination including a route with a poor road condition or a heavy traffic jam.

In an embodiment, the first prompt is automatically generated to include the vehicle's internal environment information received from the internal system of the driver's vehicle to generate a response that matches the user's purpose with respect to the destination search request.

The recommended destination may be one of the determined one or more destinations determined by various conditions. For example, a destination to which a driving distance is short, a driving time is short, nearby traffic is smooth, or service use of a destination may be smoothly used, may be determined as the recommended destination.

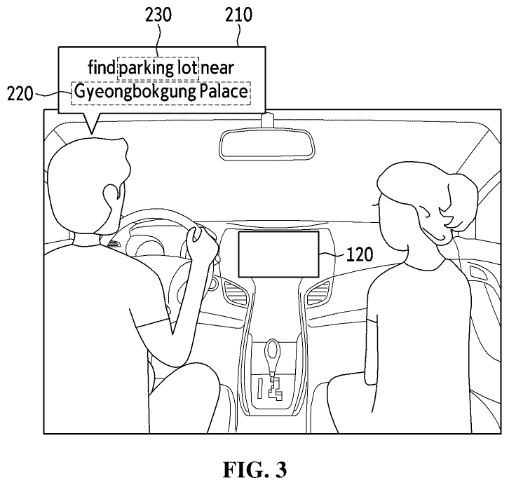

FIG. 3 is a view illustrating an example of a destination search request uttered by a driver, according to an embodiment. In an embodiment, the driver's destination search request may include voice data uttered by the driver, and the destination data 210 included in the destination search request may be obtained by converting the voice data into text data. In an embodiment, as shown in FIG. 3, the destination data 210 may include a service facility 230 corresponding to the destination search request and a base 220 of the service facility 230. In addition, the base 220 may correspond to the same address as the address of the service facility 230. For example, in the destination data 210 of the driver's destination search request for requesting to search for a parking lot near Gyeongbokgung Palace, the parking lot is the service facility 230 corresponding to the destination search request, and Gyeongbokgung Palace may correspond to the base 220 of the service facility 230.

In an embodiment, the method of FIG. 2 may further include a step or operation of automatically generating a second prompt for determining the recommended destination by using the generative AI. The second prompt may be automatically generated to include the determined one or more destinations and operating information of a service provided by each of the determined one or more destinations. The method may also include a step or operation of transmitting the second prompt to the generative AI, and a step or operation of receiving the recommended destination from the generative AI as a response to the transmission of the second prompt. The recommended destination may be determined based on an evaluation item for each of the determined one or more destinations.

The evaluation item may mean an item that is a reference for determining the recommended destination. In an embodiment, the evaluation item may include the operating information of the service provided by each of the determined one or more destinations. The service provided by each of the determined one or more destinations may mean, for example, a vehicle parking service provided by a parking lot, a gas service provided by a gas station, and the like.

In an embodiment, the operating information may include real-time parking remaining space information. The real-time parking remaining space information may mean current remaining parking remaining spaces for using a service provided by the determined one or more destinations. For example, when the determined one or more destinations are restaurants, the real-time parking remaining space information may mean whether or not a parking place is provided in the restaurants. In another example, even when the determined one or more destinations are parking lots, the real-time parking remaining space information may mean current remaining parking remaining spaces provided by the parking lot. In another embodiment, the operating information may mean information on today's operating hours. For example, when the determined one or more destinations are restaurants, the information on today's operating hours may mean the time when the restaurant provides service today.

Therefore, as the operating information of the service provided by the recommended destination in the above embodiment is output (e.g., as a voice), the driver may immediately determine the driving to the recommended destination without additional manipulation or search, thereby minimizing waste of time.

In an embodiment, the second prompt may be automatically generated to further include route information on each of the determined one or more destinations, and the evaluation item may include route information on each of the determined one or more destinations. The route information may mean a distance and a time required from the driver's location to each of the received one or more destinations. For example, when the received one or more destinations are Gyeongbokgung Palace public parking lot, the National Museum of Modern and Contemporary Art parking lot, and the Northgate Building parking lot, the route information may be that the distance is 10 km and the time required is 20 minutes for Gyeongbokgung Palace Public Parking Lot, the distance is 11 km and the time required is 25 minutes for the National Museum of Modern and Contemporary Art Parking Lot, and the distance is 19 km and the time required is 32 minutes for the Northgate Building Parking Lot. A recommendation score may be determined using the route information, so that the most suitable destination from the driver's location may be recommended, thereby saving the driver's time.

In an embodiment, the second prompt is automatically generated to further include nearby traffic information for each of the determined one or more destinations, and the evaluation item may include the nearby traffic information for each of the determined one or more destinations. The nearby traffic information may include the degree of traffic congestion in the vicinity of each of the received one or more destinations. When the received one or more destinations are Gyeongbokgung Palace public parking lot, the National Museum of Modern and Contemporary Art parking lot, and the Northgate Building parking lot, the nearby traffic information may include information such as “smooth” for the Gyeongbokgung Palace Public Parking Lot, “slightly congested” for the National Museum of Modern and Contemporary Art Parking Lot, and “very congested” for the Northgate Building Parking Lot. The recommendation score may be determined using the nearby traffic information, so that the driver's stress may be reduced compared to a route recommendation method that simply considers the distance and the time required to the destination.

In one embodiment, the evaluation item may include one or more evaluation items, and the recommended destination may receive scores equal to or greater than a reference value for all of the one or more evaluation items. A recommended destination may thus be determined depending on a plurality of evaluation items, and a destination less than a reference value in any one of the plurality of evaluation items may not be determined as a recommended destination.

In one embodiment, when a distance to a specific destination is greater than or equal to a predetermined distance, or when the time required is greater than or equal to a predetermined time, the evaluation item for the destination may be less than a reference value, and thus the destination may not be determined as a recommended destination. In another example, when traffic congestion information in the vicinity of the specific destination is very congested, the evaluation item for the destination may be less than the reference value, and thus the destination may not be determined as a recommended destination. In another example, when there is no space for a specific parking lot, the evaluation item for the parking lot may be less than the reference value, and thus the parking lot may not be determined as a recommended destination.

Since only a destination for the evaluation item is greater than or equal to a reference value, among the one or more destinations, may be determined as a recommended destination, destinations with congested traffic will not be recommended even though they are nearby stations, so that the driver's driving satisfaction may be increased. Furthermore, even though a destination is nearby and has smooth traffic, when the service is currently unavailable at the destination, since the destination will not be recommended, the driver's time may be saved and driving satisfaction may increase by preventing the driver from walking in vain.

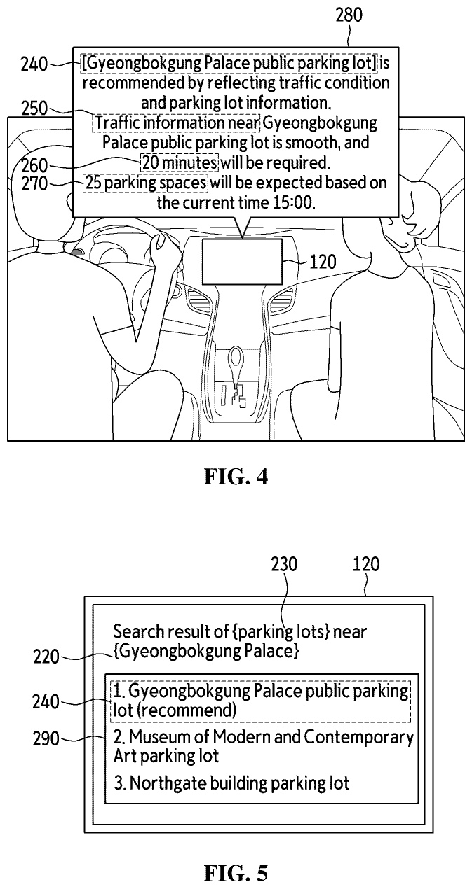

FIG. 4 is a view illustrating an example of providing information on a recommended destination in response to a destination search request, according to an embodiment.

In qn embodiment, as illustrated in FIG. 4, a response 280 to the driver's destination search request may be provided to the driver. The response 280 to the destination search request may include a recommended destination 240. Also, the response 280 to the destination search request may include nearby traffic information 250, route information 260, and operating information 270 with respect to the recommended destination 240. Therefore, the driver may recognize the reason for route recommendation by receiving the response 280 to the destination search request, including the nearby traffic information 250, the route information 260 and the operating information 270 with respect to the recommended destination 240, and may modify the destination to match the driver's purpose based on the information included in the received response 280.

FIG. 5 is a view illustrating an example of a destination list 290 displayed on the navigation device 120 corresponding to a destination search request, according to an embodiment. Referring to FIG. 5, according to an embodiment, the destination list 290 corresponding to the driver's destination search request may be displayed on the navigation device 120 mounted in the driver's mobility device. As shown in FIG. 5, in the destination list 290, the recommended destination 240 may be visually displayed differently from other destinations displayed on the navigation device 120. For example, the recommended destination 240 may be displayed by including a message “recommend” or by using a different color from destinations other than the recommended destination 240. Also, destination data 220 and 230 may be displayed together on the navigation device 120.

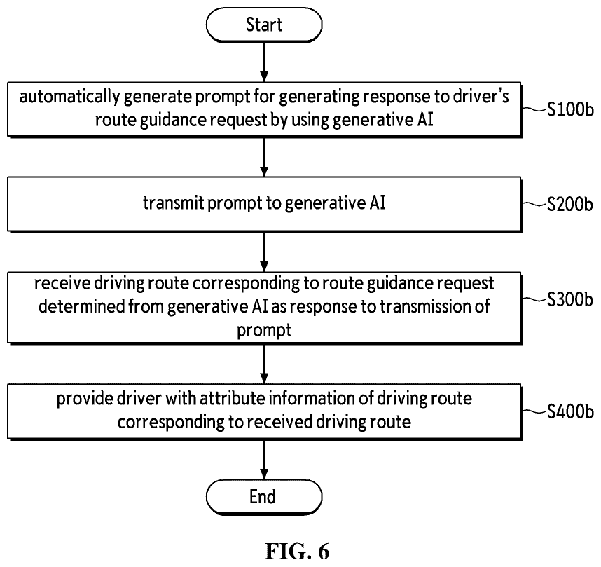

FIG. 6 is a flow chart illustrating a route recommendation method according to another embodiment.

The route recommendation method may include a step or operation S100b of automatically generating a prompt for generating a response to a driver's route guidance request by using a generative AI. The prompt may be automatically generated to include destination data included in the route guidance request. The method may also include a step or operation 200b of transmitting the prompt to the generative AI and a step or operation S300b of receiving a driving route corresponding to the route guidance request from the generative AI as a response to the transmission of the prompt. The driving route may be determined using attribute information of a predefined route, which corresponds to passenger information of the driver's mobility device, and road traffic information received from a navigation server communicatively coupled or linked to the mobility device. The method may additionally include a step or operation S400b of outputting the attribute information of the route corresponding to the received driving route to the driver.

In one embodiment, the step or operation S400b may include a step or operation of outputting the attribute information of the route corresponding to the received driving route to the driver as a voice. Accordingly, the driver may automatically receive the attribute information of the route in accordance the passenger information without a separate manipulation, thereby enhancing convenience at the time of driving and enhancing driving satisfaction. In addition, since the field of view during driving does not need to be moved to the navigation device, the driver may fully concentrate on driving, thereby enhancing driving safety.

The destination data may mean a destination name included in the driver's route guidance request. For example, in the driver's route guidance request to the Gyeongbokgung Palace public parking lot, the destination data may be “Gyeongbokgung public parking lot”.

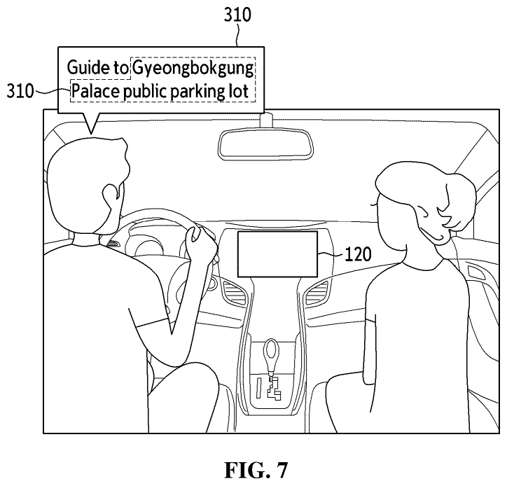

In an embodiment, the driver's route guidance request may include voice data uttered by the driver. In addition, the destination data included in the route guidance request may be obtained by converting the voice data into text data. The present embodiment is described in more detail below with reference to FIG. 7.

FIG. 7 is a view illustrating an example of a route guidance request uttered by a driver.

As shown in FIG. 7, the driver's route guidance request 310 may include voice data uttered by the driver. Also, the route guidance request 310 may include destination data 320. In an embodiment, the destination data 320 included in the route guidance request 310 may be converted into text data in order to automatically generate a prompt for generating a response according to the route guidance request 310.

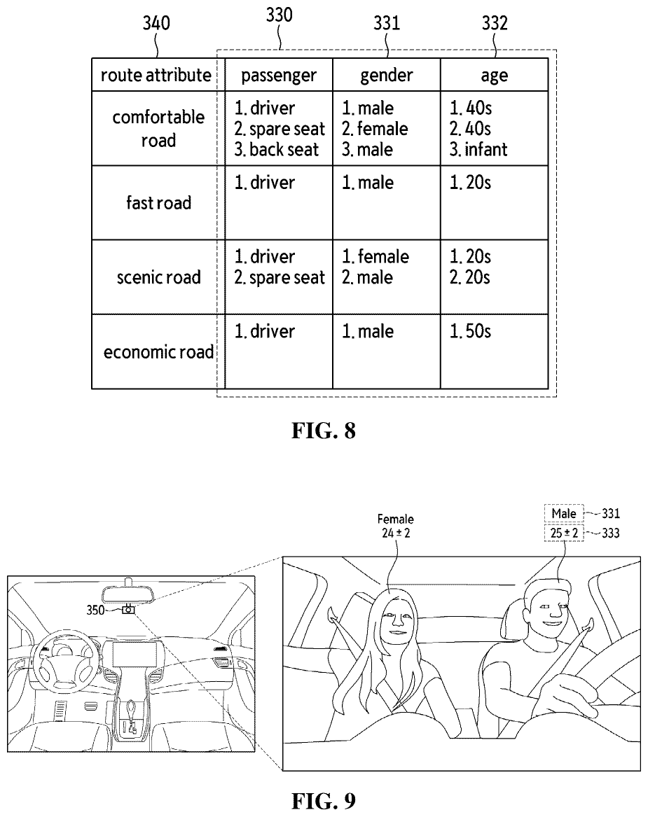

FIG. 8 is a view illustrating a correspondence relation between passenger information 330 of the driver's mobility device and attribute information 340 of a predefined route, according to an embodiment.

The passenger information 330 may mean personal information of a passenger who rides in the mobility device of the driver. In an embodiment, the passenger information 330 may include gender information 331 of a passenger who rides in the mobility device. In another embodiment, the passenger information 330 may include age information 332 of a passenger who rides in the mobility device.

As shown in FIG. 8, the attribute information 340 of the predefined route may correspond to the passenger information 330. For example, the passenger information 330 such as a couple in their 40s who ride together with an infant may correspond to attribute information 340 of a predefined route called “a comfortable road”. A route to be guided may be provided in accordance with the passenger information, so that a driving route optimized for the passenger may be provided.

FIG. 9 is a view illustrating an example of acquiring passenger information of a driver's mobility device through a camera inside the mobility device, according to an embodiment.

The passenger information 330 may be information acquired by an indoor camera 350 mounted inside the mobility device. In an embodiment, as shown in FIG. 9, the indoor camera 350 may be mounted on an upper end of a front seat of the mobility device to acquire passenger information such as age or gender of the passenger.

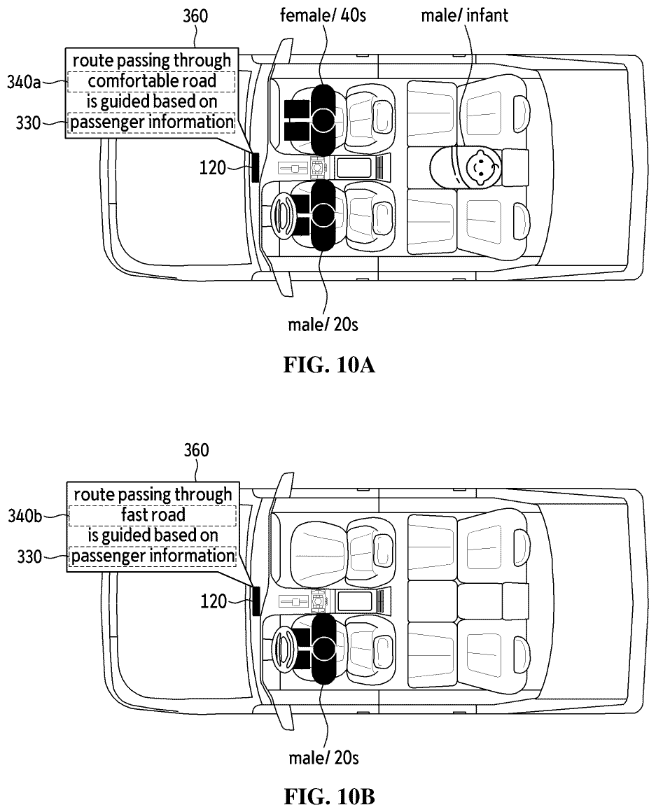

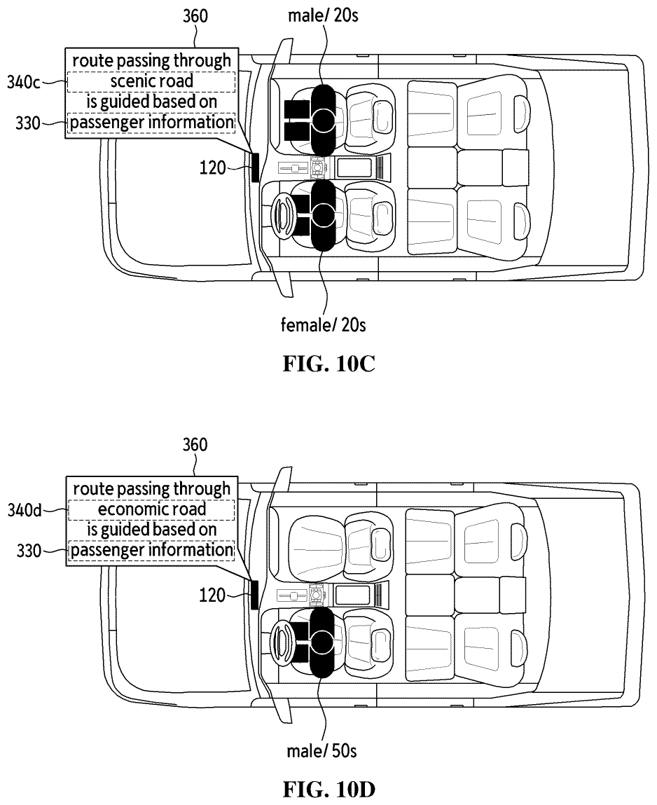

FIGS. 10A-10D are views illustrating an example of providing a driving route to a driver based on attribute information of a predefined route corresponding to passenger information of a driver's mobility device, according to embodiments.

In one embodiment, as shown in FIG. 10A, when the passenger information 330 includes an infant, a man in his 40s, and a woman in her 40s, the attribute information of the predefined route corresponding to the passenger information 330 may be a comfortable road 340a. Accordingly, a response 360 corresponding to the driver's route guidance request may be provided to the driver by including 340a. However, it should be noted that passenger information corresponding to the comfortable road 340a as in the above example is not limited to information of a man in his 40s and a woman in her 40s, who are on board with an infant. For example, even when the passenger information includes a man in his 30s, a woman in her 20s, and an infant, the passenger information may correspond to the comfortable road 340a. Accordingly, even when a passenger who has a reason to travel via the comfortable road 340a such as safety of an infant is on board, the passenger may correspond to the comfortable road 340a.

In another embodiment, as shown in FIG. 10A, when a man in his 20s is included in the passenger information 330, the attribute information of the predefined route corresponding to the passenger information 330 may be a fast road 340b. Accordingly, the response 360 according to the driver's route guidance request may be provided to the driver by including 340b. However, it should be noted that the passenger information corresponding to the fast road 340b as in the above-described example is not limited to men in their 20s. For example, even when passenger information includes a man in his 30s, the passenger information may correspond to the fast road 340b. Accordingly, the fast road 340b may correspond to other types of passenger information having a reason to arrive at the destination within a short time.

In another embodiment, as shown in FIG. 10C, when the passenger information 330 includes a man in his 20s and a woman in her 20s, the attribute information of the predefined route corresponding to the passenger information 330 may be a scenic road 340c. Accordingly, the response 360 according to the driver's route guidance request may be provided to the driver by including 340c. However, it should be noted that passenger information corresponding to the scenic road 340c is not limited to a man in his 20s and a woman in her 20s. For example, even when the passenger information includes a man in his 30s and a woman in her 20s, it may correspond to the scenic road 340c. Accordingly, the scenic road 340c may also correspond to other types of passenger information having a reason to drive for psychological refreshment.

In another embodiment, when a man in his 50s is included in the passenger information 330 as shown in FIG. 10D, the attribute information of the predefined route corresponding to the passenger information 330 may be an economic road 340d. Accordingly, the response 360 according to the driver's route guidance request may be provided to the driver by including 340d. However, it should be noted that the passenger information corresponding to the economic road 340d is not limited to men in their 50s as in the above-described example. For example, even when the passenger information includes a woman in her 50s, the passenger information may correspond to the economic road 340d. Accordingly, the economic road 340d may correspond to other types of passenger information that tend to take the financial aspect as important.

As described above, the response to the route guidance is automatically generated in consideration of the passenger information, so that the driver's driving concentration is increased to improve safety and driving efficiency is enhanced. In addition, a more sophisticated personalized route may be recommended using driving data according to the passenger information.

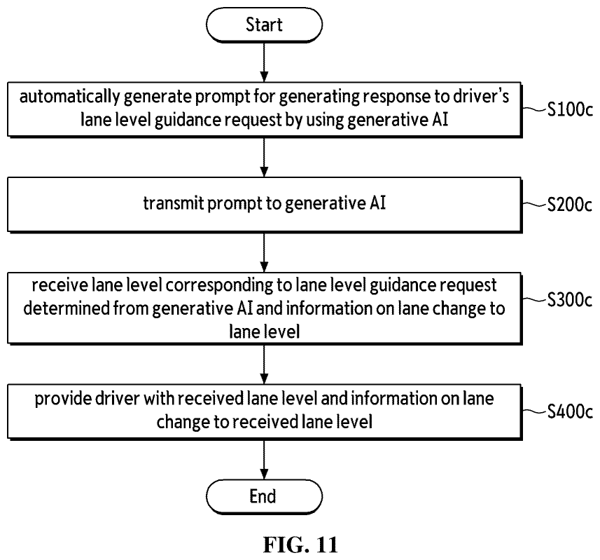

FIG. 11 is a flow chart illustrating a route recommendation method according to another embodiment of the present disclosure.

The route recommendation method according to an embodiment may include a step or operation S100c of automatically generating a prompt for generating a response to a driver's lane level guidance request by using a generative AI. The prompt may be automatically generated to include the lane level guidance request and internal environment information received from an internal system of the driver's vehicle. The method may also include a step or operation 200c of transmitting the prompt to the generative AI and a step or operation S300c of receiving a lane level corresponding to the lane level guidance request determined from the generative AI and information on a point where lane change to the lane level is to be performed. The information on a point where lane change is to be performed may be determined using forward traffic information received from a navigation server communicatively coupled or linked to the driver's vehicle or the internal system of the vehicle. The method may additionally include a step or operation S400c of providing the driver with the received lane level and the information on a point where lane change is to be performed.

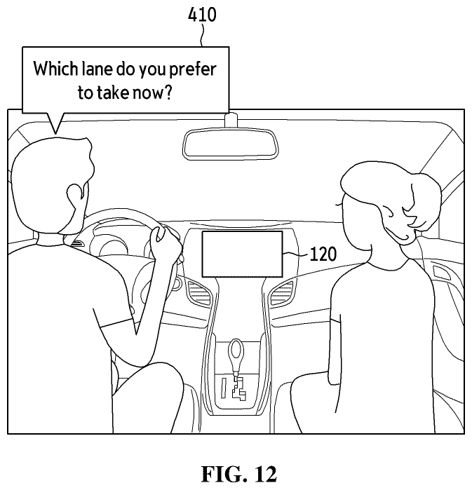

FIG. 12 is a view illustrating an example of a lane level guidance request uttered by a driver, according to an embodiment. In an embodiment, as shown in FIG. 12, the driver's lane level guidance request 410 may include voice data uttered by the driver. In addition, the lane level guidance request may be obtained by converting the voice data into text data.

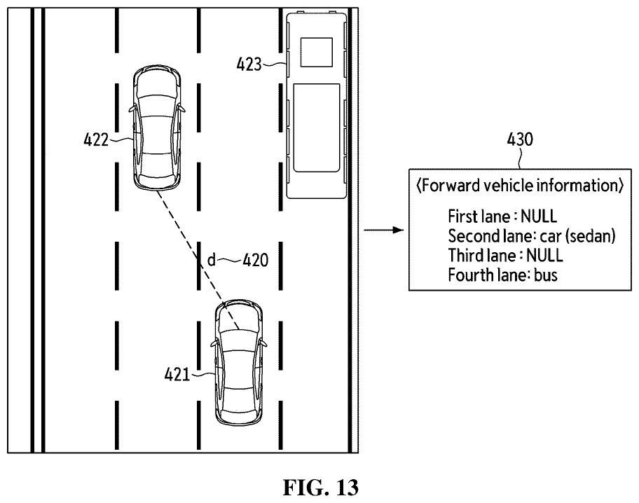

FIG. 13 is a view illustrating an example of acquiring information on a mobility device driving within a certain distance ahead of a driver's mobility device, according to an embodiment.

In an embodiment, forward traffic information 430 may include information on mobility devices 422 and 423 driving ahead within a predetermined distance ‘d’ 420 of the driver's mobility device 421. Referring to FIG. 13, the forward traffic information 430 may include information on the mobility devices 422 and 423 driving ahead within the predetermined distance ‘d’ 420 of the driver's mobility device 421 for each lane level. The forward traffic information 430 may be information acquired from a front camera of the driver's mobility device 421. Since a response to a lane level guidance request is generated in consideration of the forward traffic information, a location of a nearby vehicle of a driver may be analyzed so that a risk of collision may be reduced during lane change. In addition, the road environment in real time may be analyzed through the front camera and the generative AI, so that the optimal timing for lane change may be provided to the driver.

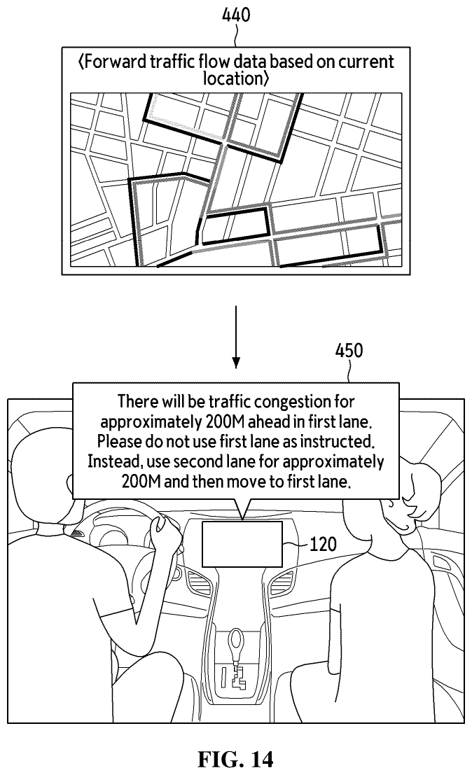

FIG. 14 is a view illustrating an example of avoidance route guidance using traffic information for each lane level to a destination, according to an embodiment.

In an embodiment, the forward traffic information may include traffic information 440 for each lane level from a location of the driver's mobility device to the driver's driving destination. In an embodiment, the step or operation S400c may further include a step or operation of providing the driver with an avoidance route guidance using the traffic information for each level. Referring to FIG. 14, the forward traffic information may include traffic information 440 for each lane level to the driving destination, and the traffic information for each lane level to the driving destination may include the degree of traffic congestion for each lane level to the driving destination.

The traffic information 440 for each lane level to the driving destination may be displayed on the screen of the navigation device 120 so that the degree of congestion for each lane is visually classified for each lane level.

Referring to FIG. 14, an avoidance route guidance 450 may mean a guidance for providing a driving route to a destination through a lane level in which a traffic situation is smooth in consideration of the traffic information 440 for each lane level. For example, when a lane level is changed from a third lane to a first lane in order to reach a destination, and when a road congestion of about 200 M ahead is scheduled, unlike the existing route guidance, a guidance for changing a lane level to the first lane after 200 M driving on a second lane may be provided. The existing route guidance may mean turn-by-turn information displayed through the navigation device. In one embodiment, the avoidance route guidance 450 may be received from the generative AI by using the traffic information 440 for each lane level.

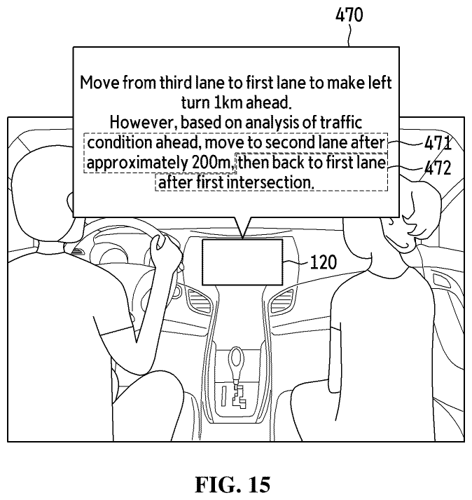

FIG. 15 is a view illustrating an example of a voice output of a lane level and a point where lane change to the lane level is performed, based on a lane level guidance request, according to an embodiment. In an embodiment, a response 470 according to the driver's lane level guidance request may include a lane level corresponding to the lane level guidance request and information on a point where lane change to the lane level is performed.

In addition, the information on a point where lane change to the lane level is performed may include location information for moving from a current lane level to an intermediate lane level of the driver, and location information for moving from the intermediate lane level to a target lane level, when a plurality of lane levels are changed. For example, as shown in FIG. 15, when two lanes are to be moved from the third lane to the first lane ahead of 1 KM, the second lane, which is the intermediate lane level, may be guided to change the lane level by moving 200M from the current lane level and to change the lane level by passing a first intersection from the second lane, which is the intermediate lane level, to the first lane that is the target lane level. The target lane level may mean a lane level corresponding to the driver's lane level guidance request.

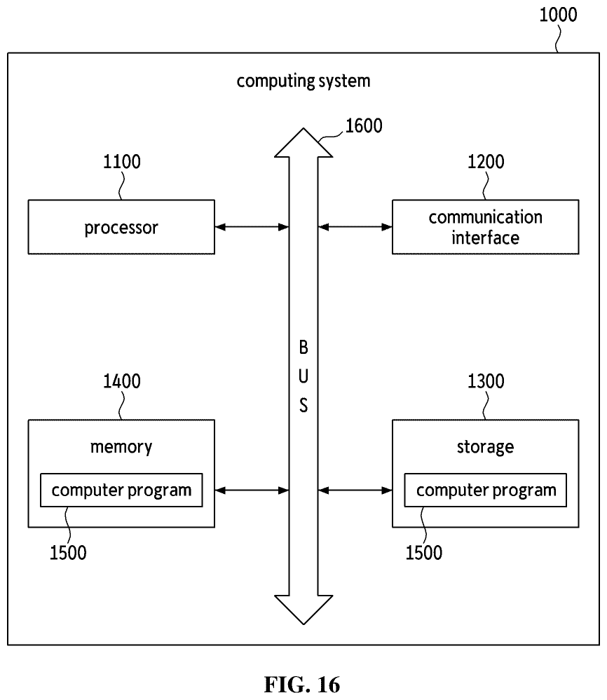

FIG. 16 is a hardware schematic diagram illustrating a computing device described in some embodiments of the present disclosure.

Referring to FIG. 16, a computing device 1000 may include one or more processors 1100, a bus 1600, a communication interface 1200, a memory 1400 for loading a computer program executed by the processor 1100, and a storage 1300 for storing the computer program 1500. In FIG. 16, only components related to embodiments of the present disclosure are shown. Accordingly, it should be apparent to those having ordinary skill in the art to which the present disclosure pertains that the computing device may further include other general-purpose components in addition to the components shown in FIG. 16. The computing device 1000 may further include various components in addition to the components shown in FIG. 16. Also, in some cases, the computing device 1000 may be configured in a form in which some of the components shown in FIG. 16 are omitted. Hereinafter, each component of the computing device 1000 is described in more detail. Throughout the present disclosure, the computing device 1000 and the computing system are terms that may be used interchangeably.

The processor 1100 may control the overall operation of each component of the computing device 1000. The processor 1100 may include at least one of a central processing unit (CPU), a micro-processor unit (MPU), a micro controller unit (MCU), a graphic processing unit (GPU), or any type of processor well known in the technical field of the present disclosure. In addition, the processor 1100 may perform computation on at least one application or program for executing an operation/method according to the embodiments of the present disclosure. The computing device 1000 may include two or more processors.

The memory 1400 stores various types of contents, commands and/or information. The memory 1400 may load one or more programs 1500 from the storage 1300 to execute the methods/operations according to the embodiments of the present disclosure. The memory 1400 may be implemented as a volatile memory such as RAM, but the present disclosure is not limited thereto.

The bus 1600 provides a communication function between components of the computing device 1000. The bus 1600 may be implemented as various types of buses such as an address bus, a data bus, and a control bus.

The communication interface 1200 supports wired/wireless Internet communication of the computing device 1000. The communication interface 1200 may support various communication modes other than Internet communication. To this end, the communication interface 1200 may be configured to include a communication module well known in the technical field of the present disclosure.

The storage 1300 may non-temporarily store one or more computer programs 1500. The storage 1300 may include a nonvolatile memory such as a Read Only Memory (ROM), an Erasable Programmable ROM (EPROM), an Electrically Erasable Programmable ROM (EEPROM) and a flash memory, a hard disk, a detachable disk, or any type of computer-readable recording medium well known in the technical field to which the present disclosure pertains.

The computer program 1500 may include one or more steps to allow the processor 1100 to perform operation/methods according to various embodiments of the present disclosure when loaded into the memory 1400. The processor 1100 may perform the methods/operations according to various embodiments of the present disclosure by executing one or more steps.

For example, the computing device of FIG. 16 may be a computing device included in the vehicle environment control system described with reference to FIG. 1. In this case, the computing device described with reference to FIG. 16 may be configured using one or more physical servers included in a server farm based on a cloud technology such as a virtual machine. In this case, at least a portion of the processor 1100, the memory 1400, and the storage 1300 among the components shown in FIG. 16 may be virtual hardware, and the communication interface 1200 may also be configured as a virtualized networking element such as a virtual switch. The various embodiments of the present disclosure and the effects according to the embodiments have been described as above with reference to FIGS. 1-16. The effects according to the technical spirits of the present disclosure are not limited to the above-mentioned effects, and other effects not mentioned may be clearly understood by those having ordinary skill in the art from the following description.

The computer program 1500 according to an embodiment may include computer-readable instructions for automatically generating a first prompt for generating a response to a driver's destination search request by using a generative AI, the first prompt being automatically generated to include internal environment information of a mobility device, which is received from an internal system of the driver's mobility device, transmitting the first prompt to the generative AI, determining one or more destinations corresponding to the destination search request from the generative AI as a response to the transmission of the first prompt, the response being generated using road traffic information received from a navigation server communicatively coupled or linked to the mobility device, and determining a recommended destination among the determined one or more destinations.

So far, a variety of embodiments of the present disclosure and the effects according to embodiments thereof have been mentioned with reference to FIGS. 1-16. The effects according to the technical idea of the present disclosure are not limited to the forementioned effects. Other effects that are not mentioned herein may be clearly understood by those having ordinary skill in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

Those having ordinary skill in the art should appreciate that many variations and modifications can be made to the embodiments described herein without substantially departing from the principles of the present disclosure. Therefore, the described embodiments of the present disclosure are used in a generic and descriptive sense only and not for purposes of limitation.

What is claimed is:

1. A method, performed by a computing system, for recommending a driving route for a mobility device, the method comprising:
automatically generating a first prompt for generating, by using generative AI, a response to a destination search request of a driver, the first prompt being automatically generated to include internal environment information received from an internal system of the mobility device;
transmitting the first prompt to a generative AI system;
receiving one or more destinations corresponding to the destination search request, from the generative AI system in response to transmitting the first prompt, wherein the response is generated using road traffic information received from a navigation server communicatively coupled to the mobility device; and
determining a recommended destination from among the one or more destinations received from the generative AI system.

2. The method of claim 1, wherein the destination search request includes a service facility corresponding to the destination search request and a base of the service facility.

3. The method of claim 1, wherein determining the recommended destination includes:
automatically generating a second prompt for determining, by using generative AI, the recommended destination, the second prompt being automatically generated to include the one or more destinations and operating information of a service provided by each of the one or more destinations;
transmitting the second prompt to the generative AI system; and
receiving the recommended destination from the generative AI system in response to transmitting the second prompt,
wherein the recommended destination is determined based on an evaluation item for each of the one or more destinations.

4. The method of claim 3, wherein the evaluation item includes the operating information of the service provided by each of the one or more destinations.

5. The method of claim 3, wherein:
the second prompt is automatically generated to further include route information on each of the one or more destinations; and
the evaluation item includes the route information on each of the one or more destinations.

6. The method of claim 3, wherein:
the second prompt is automatically generated to further include nearby traffic information on each of the one or more destinations; and
the evaluation item includes the nearby traffic information on each of the one or more destinations.

7. The method of claim 3, wherein:
the evaluation item includes one or more evaluation items; and
the recommended destination receives a score of a reference value or more with respect to all of the one or more evaluation items.

8. The method of claim 3, wherein the operating information includes real-time parking remaining space information.

9. The method of claim 3, wherein the operating information includes information on operating hours of the service.

10. A method, performed by a computing system, for recommending a driving route for a mobility device, the method comprising:
automatically generating a prompt for generating, by using generative AI, a response to a route guidance request of a driver, the prompt being automatically generated to include destination data included in the route guidance request;
transmitting the prompt to a generative AI system; and
receiving a driving route corresponding to the route guidance request, from the generative AI system in response to transmitting the prompt, wherein the driving route is determined based on i) route attribute information that corresponds to passenger information of a passenger riding in the mobility device and ii) road traffic information received from a navigation server communicatively coupled to the mobility device.

11. The method of claim 10, wherein:
the route guidance request includes voice data uttered by the driver; and
the destination data included in the route guidance request is obtained by converting the voice data into text data.

12. The method of claim 10, wherein the passenger information includes age information of the passenger riding in the mobility device.

13. The method of claim 10, wherein the passenger information includes gender information of the passenger riding in the mobility device.

14. The method of claim 10, further comprising outputting the route attribute information corresponding to the driving route as a voice output in the mobility device.

15. A method, performed by a computing system, for recommending a driving route for a mobility device, the method comprising:
automatically generating a prompt for generating, by using generative AI, a response to a lane level guidance request of a driver, the prompt being automatically generated to include the lane level guidance request and internal environment information received from an internal system of the mobility device;
transmitting the prompt to a generative AI system; and
receiving a lane level corresponding to the lane level guidance request and information on a point where lane change to the lane level is to be performed, from the generative AI system in response to transmitting the prompt, wherein the information on the point where the lane change is to be performed is determined using forward traffic information received from one or both of a navigation server communicatively coupled to the mobility device or the internal system of the mobility device.

16. The method of claim 15, wherein the information on the point where lane change is to be performed includes location information for moving from a current lane level to an intermediate lane level and location information for moving from the intermediate lane level to a target lane level.

17. The method of claim 15, wherein the forward traffic information includes information on another mobility device, driving ahead within a certain distance of the mobility device, received from the internal system of the mobility device.

18. The method of claim 15, wherein the forward traffic information includes traffic information for each lane level from a location of the mobility device to a destination of the driver, wherein the traffic information is received from the navigation server communicatively coupled to the mobility device.

19. The method of claim 15, further comprising outputting an avoidance route guidance using the forward traffic information.

20. The method of claim 15, wherein the internal environment information includes passenger information of the mobility device.
